(19) United States
(12) Patent Application Publication
(10) Pub. No.: US 2009/0157921 A1
(43) Pub. Date: Jun. 18, 2009

(54) KVM MANAGEMENT SYSTEM AND METHOD

(75) Inventor: Sheng-Peng Lin, Taipei (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: ATEN INTERNATIONAL CO., LTD., Taipei (TW)

(21) Appl. No.: 11/954,431

(22) Filed: Dec. 12, 2007

(51) Int. Cl. G06F 13/12

(52) U.S. Cl. 710/72

(57) ABSTRACT

A KVM management system is provided. The KVM management system comprises at least one KVM switch and a KVM recorder. The KVM switch comprises a plurality of ports for connecting to a plurality of computers, respectively. The KVM recorder comprises a storage device, and couples to the KVM switch. The KVM recorder receives and records operations on the KVM switch to the storage device.

### BACKGROUND OF THE INVENTION

1. Field of the Invention

The disclosure relates generally to KVM management systems and methods, and, more particularly to KVM management systems and methods that receive and record operations and related information on at least one KVM switch.

2. Description of the Related Art

A KVM switch is a hardware device that allows a user to control multiple hosts such as computers from a keyboard, video monitor and mouse. The KVM switch will pass signals between the hosts and the keyboard, video monitor and mouse.

The KVM switch will generate related data for operations, and receive or output videos and/or audios via the ports. Conventionally, the life cycle of the data generated or processed by the KVM switch is short. That is, the data will be quickly discarded after it has been generated and used. Thus, further analysis is required, since there is no mechanism to store, retrieve, play back or manage specified data of the KVM switch, no way to retrieve, play back, or manage interested data for further analysis.

### BRIEF SUMMARY OF THE INVENTION

KVM management systems and methods are provided.

An embodiment of a KVM management system comprises at least one KVM switch and a KVM recorder. The KVM switch comprises a plurality of ports for connecting to a plurality of computers, respectively. The KVM recorder comprises a storage device, and couples to the KVM switch. The KVM recorder receives and records operations on the KVM switch to the storage device.

An embodiment of a KVM management system comprises a first KVM switch and a second KVM switch. The first KVM switch comprises a plurality of first ports for connecting to a plurality of first computers, respectively. The second KVM switch connects to the first KVM switch, and comprises a plurality of second ports for connecting to a plurality of second computers, respectively. The first KVM switch receives and records first operations on the second KVM switch, or the second KVM switch receives and records second operations on the first KVM switch.

In an embodiment of a KVM management method, operations are performed on a KVM switch. The operations are received and recorded from the KVM switch via a first network. The first network includes Internet, Ethernet, Intranet, wide area network (WAN), local area network (LAN) or wireless network.

KVM management systems and methods may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of a KVM management system according to the invention;

FIG. 2 is a schematic diagram illustrating another embodiment of a KVM management system according to the invention;

FIG. 3 is a flowchart of an embodiment of a KVM management method according to the invention; and

FIG. 4 is a flowchart of another embodiment of a KVM management method according to the invention.

### DETAILED DESCRIPTION OF THE INVENTION

KVM management systems and methods are provided.

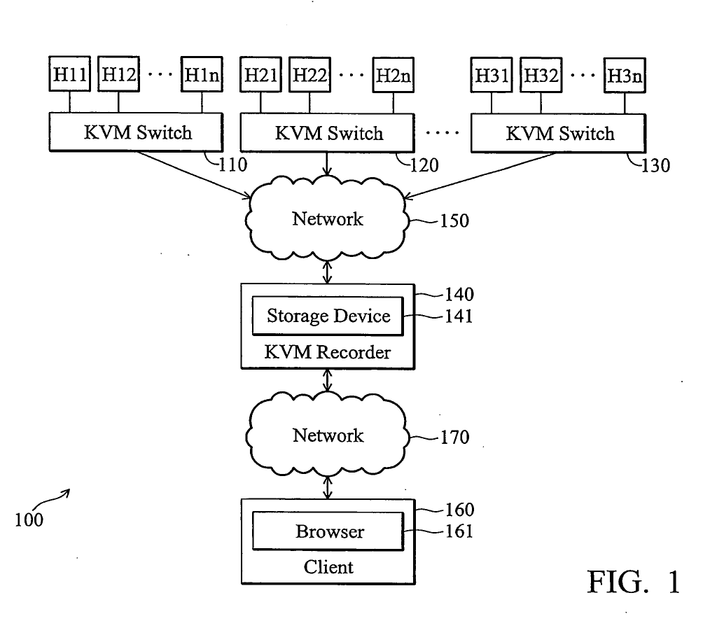

FIG. 1 is a schematic diagram illustrating an embodiment of a KVM management system according to the invention.

As shown in FIG. 1, the KVM management system 100 comprises a plurality of KVM switches 110, 120 and 130. Respective KVM switches comprise a plurality of ports for connecting to a plurality of hosts such as computers, respectively. For example, the KVM switch 110 comprises ports for connecting to hosts H11, H12 and H1n, respectively. The KVM switch 120 comprises ports for connecting to hosts H21, H22 and H2n, respectively. The KVM switch 130 comprises ports for connecting to hosts H31, H32 and H3n, respectively. The KVM switches 110, 120 and 130 commonly couple to a KVM recorder 140 via a network 150. The network 150 may be an Internet, Ethernet, Intranet, wide area network (WAN), local area network (LAN), or wireless network. The KVM recorder 140 comprises a storage device 141 such as a hard drive, a flash memory, or a disc recorder. The KVM recorder 140 receives operations and/or time information for the operations performed on the KVM switches, and records the operations to the storage device 141. The operations comprise keyboard and mouse operations on the KVM switch, videos from the ports, audios from the ports, videos output via the ports, audios output via the ports, log-in and log-out logs on the KVM switch, booting logs of the KVM switch, access logs of the KVM switch, and others. Additionally, a client 160 may couple to the KVM recorder 140 via a network 170, and retrieve and/or play back the operations using a browser 161. The network 170 may be an Internet, Ethernet, Intranet, wide area network (WAN), local area network (LAN), or wireless network. In one embodiment, the KVM recorder may be disposed in one of the KVM switches 110, 120 and 130.

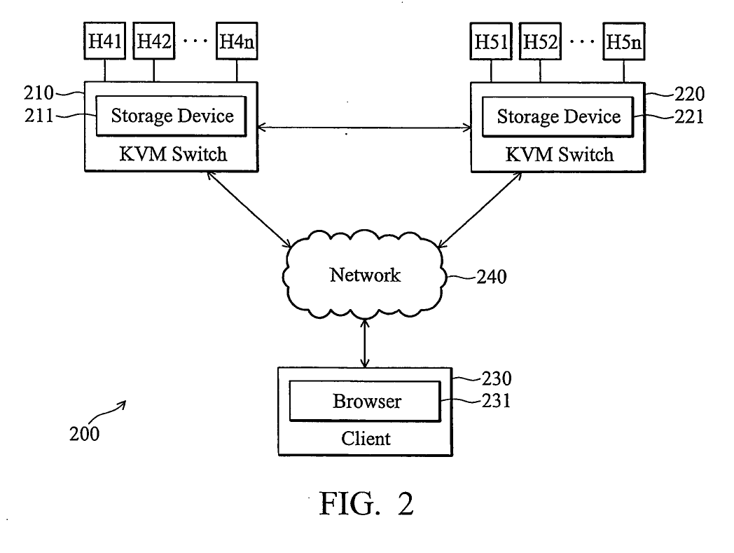

FIG. 2 is a schematic diagram illustrating another embodiment of a KVM management system according to the invention. In this embodiment, the KVM recorder in the embodiment of FIG. 1 is built in the KVM switch.

As shown in FIG. 2, the KVM management system 200 comprises at least two KVM switches 210 and 220. Respective KVM switches comprise a plurality of ports for connecting to a plurality of hosts such as computers, respectively. In this embodiment, the KVM switch 210 comprises ports for connecting to hosts H41, H42 and H4n, respectively. The KVM switch 220 comprises ports for connecting to hosts H51, H52 and H5n, respectively. The KVM switch 210 may connect to the KVM switch 220 in cascade chain or daisy chain, or via a network such as an Internet, Ethernet, Intranet, wide area network (WAN), local area network (LAN) or wireless network. Additionally, respective KVM switches comprise a storage device such as a hard drive, a flash memory, or a disc recorder. Respective KVM switches can record operations and/or time information for the operations performed thereon and/or on other KVM switches to the corresponding storage device. For example, the KVM switch 210 can record operations and/or time information for the operations performed thereon and/or on the KVM switch 220 to the storage device 211. The KVM switch 220 can record operations and/or time information for the operations performed thereon and/or on the KVM switch 210 to the storage device 221. Similarly, the operations comprise keyboard and mouse operations on the KVM switch, videos from the ports, audios from the ports, videos output via the ports, audios output via the ports, log-in and log-out logs on the KVM switch, booting logs of the KVM switch, access logs of the KVM switch, and others. Additionally, a client 230 may couple to the KVM switches 210 and 220 via a network 240, and retrieve and/or play back the operations using a browser 231. The network 240 may be an Internet, Ethernet, Intranet, wide area network (WAN), local area network (LAN), or wireless network. In one embodiment, the KVM switch 210 records operation information from the KVM switch 220 via direct connecting cable between the KVM switches 210 and 220 or the network 240. In other embodiment, the KVM switch 220 records operation information from the KVM switch 210 via direct connecting cable between the KVM switches 210 and 220 or the network 240.

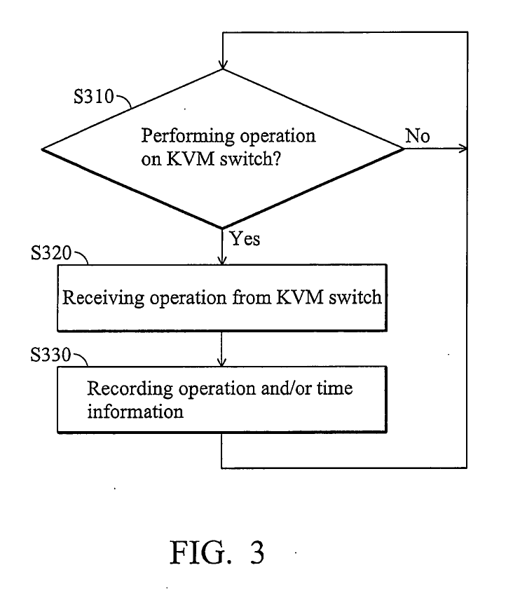

FIG. 3 is a flowchart of an embodiment of a KVM management method according to the invention.

In step S310, it is determined whether any operation is performed on a KVM switch. If not (No in step S310), the procedure remains at step S310. If so (Yes in step S310), in step S320, the operation is received from the KVM switch, and in step S330, the operation and time information for the operation are recorded. Similarly, the operation may comprise keyboard and mouse operations on the KVM switch, videos from the ports, audios from the ports, videos output via the ports, audios output via the ports, log-in and log-out logs on the KVM switch, booting logs of the KVM switch, access logs of the KVM switch, and others. It is understood that, in some embodiments, the time information is the occurrence time of the operation, and received with the operation from the KVM switch. In some embodiments, the time information is the reception or recording time of the operation.

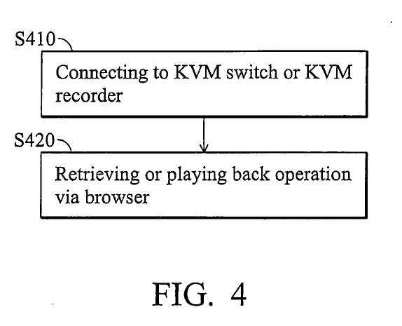

FIG. 4 is a flowchart of another embodiment of a KVM management method according to the invention.

In step S410, a client connects to a KVM switch or a KVM recorder via a network. In step S420, the operations are retrieved or played back according to a specific time point, a specific port among the ports of the KVM switch, the KVM switch, or a specific user ID. It is understood that an authorization mechanism may be provided with operation retrieval. Under the authorization mechanism, respective users may be provided a unique user ID having specific authority to retrieve all or part of the operations.

KVM management systems and methods, or certain aspects or portions thereof, may take the form of a program code (i.e., executable instructions) embodied in tangible media, such as products, floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A KVM management system, comprising:
at least one KVM switch comprising a plurality of ports for connecting to a plurality of computers, respectively; and
a KVM recorder coupled to the KVM switch, comprising a storage device, receiving and recording operations on the KVM switch to the storage device.

2. The system of claim 1, wherein the KVM recorder further records time information when the operations occur.

3. The system of claim 1, wherein the operations comprise keyboard and mouse operations on the KVM switch, videos from the ports, audios from the ports, videos output via the ports, audios output via the ports, log-in and log-out logs on the KVM switch, booting logs of the KVM switch, or access logs of the KVM switch.

4. The system of claim 1, wherein the operations are retrieved according to a specific time point, a specific port among the ports, the KVM switch, or a specific user ID.

5. The system of claim 1, wherein the KVM recorder is built in the KVM switch, or externally coupled to the KVM switch.

6. The system of claim 1, further comprising a client to connect to the KVM recorder to retrieve or playback the operations using a browser.

7. The system of claim 1, wherein the storage device comprises a hard drive, a flash memory, or a disc recorder.

8. A KVM management system, comprising:
a first KVM switch comprising a plurality of first ports for connecting to a plurality of first computers, respectively; and
a second KVM switch connected to the first KVM switch, comprising a plurality of second ports for connecting to a plurality of second computers, respectively;
wherein the first KVM switch receives and records operations on the first or the second KVM switch, or the second KVM switch receives and records operations on the first or the second KVM switch.

9. The system of claim 8, wherein the first KVM switch is connected to the second KVM switch in cascade chain, or daisy chain.

10. The system of claim 8, wherein the first KVM switch is connected to the second KVM switch via a network.

11. The system of claim 8, wherein the first KVM switch records time information when the operations occur, or the second KVM switch records time information when the operations occur.

12. The system of claim 8, wherein the operations comprise keyboard and mouse operations on the first or the second KVM switch, videos from the first or the second ports, audios from the first or the second ports, videos output via the first or the second ports, audios output via the first or the second ports, log-in and log-out logs on the first or the second KVM switch, booting logs of the first or the second KVM switch, or access logs of the first or the second KVM switch.

13. The system of claim 8, wherein the operations are retrieved according to a specific time point, a specific port among the first or the second ports, the first or the second KVM switch, or a specific user ID.

14. The system of claim 8, further comprising a client to connect to the first or the second KVM switch to retrieve or playback the operations using a browser.

15. A KVM management method, comprising:
performing operations on a KVM switch; and
receiving and recording the operations from the KVM switch via a first network.

16. The method of claim 15, further comprising recording time information when the operations occur on the KVM switch.

17. The method of claim 15, wherein the operations comprise keyboard and mouse operations on the KVM switch, videos from the ports, log-in and log-out logs on the KVM switch, booting logs of the KVM switch, or access logs of the KVM switch.

18. The method of claim 15, further comprising retrieving the operations according to a specific time point, a specific port among the ports, the KVM switch, or a specific user ID.

19. The method of claim 15, wherein the first network is an internal network within the KVM switch or an external network of the KVM switch.

20. The method of claim 15, further comprising retrieving or playing back the operations using a browser via a second network by a client.
